(19) United States
(12) Patent Application Publication
(10) Pub. No.: US 2016/0183300 A1
(43) Pub. Date: Jun. 23, 2016

(54) METHODS, WIRELESS COMMUNICATION STATIONS, AND SYSTEM FOR OPERATING IN THE 5 GHZ FREQUENCY BAND

(71) Applicants: Shahrnaz Azizi, Cupertino, CA (US); Thomas J Kenney, Portland, OR (US); Eldad Perahia, Portland, OR (US)

(72) Inventors: Shahrnaz Azizi, Cupertino, CA (US); Thomas J Kenney, Portland, OR (US); Eldad Perahia, Portland, OR (US)

(21) Appl. No.: 14/127,605

(22) PCT Filed: Sep. 26, 2013
(86) PCT No.: PCT/US2013/061988

§ 371 Date: Dec. 19, 2013

Related U.S. Application Data
(60) Provisional application No. 61/821,875, filed on May 10, 2013.

(51) Int. Cl. H04W 74/08

(52) U.S. Cl. CPC H04W 74/0808

(57) ABSTRACT

Embodiments of a user station (STA) and methods for operating in a wireless communication network are generally described herein. In some embodiments, a STA detects that a signal, received on a wireless communication channel, was transmitted by a device operating with a bandwidth of a set of bandwidths. The set of bandwidths can include a 5 MHz bandwidth and a 10 MHz bandwidth. The STA may determine, responsive to the detecting, contents of a signal (SIG) field of the signal. The STA may apply a coexistence technique, such as refraining from transmitting STA transmissions, on the channel responsive to the detecting and based on information of the SIG field.

### PRIORITY CLAIM

This application claims priority to U.S. Provisional Patent Application No. 61/821,875, filed on May 10, 2013, the content of which is incorporated herein by reference in its entirety.

### TECHNICAL FIELD

Embodiments pertain to communication networks. Some embodiments pertain to coexistence techniques for devices that operate in accordance with one of the IEEE 802.11 standards, including the IEEE 802.11n and IEEE 802.11 ac standards.

### BACKGROUND

Recently, the Federal Communications Commission (FCC) has proposed modifications of the existing rules governing Unlicensed-National Information Infrastructure (U-NII) to allow shared access for U-NII devices on some sub-bands of the 5 GHz frequency band. Wi-Fi devices operating according to a standard from an IEEE 802.11 wireless standards family may expand their operating bands to take advantage of these expansion bands. However, Wi-Fi devices may need to coexist with governmental or other types of incumbent devices that may have precedence in the expansion bands.

### BRIEF DESCRIPTION OF THE DRAWINGS

FIG. 1 illustrates a system in which example embodiments are implemented.

FIG. 2 is a block diagram of STA architecture for coexisting with devices on the 5 GHz frequency band.

FIG. 3 is a flow diagram of a procedure performed by a station (STA) for operating in a wireless network, in accordance with some embodiments.

FIG. 4 illustrates a functional block diagram of a STA, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

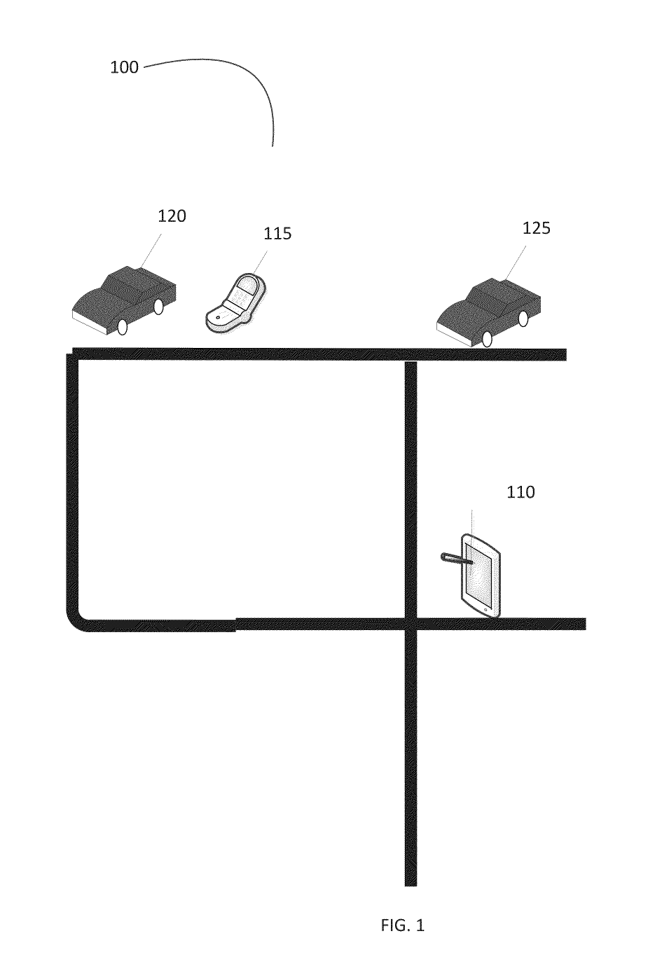

FIG. 1 illustrates a system 100 in which example embodiments can be implemented. System 100 includes user wireless communication stations (STAs) 110 and 115 that operate in accordance with a standard of the Institute of Electrical and Electronics Engineers (IEEE) 802.11 family of wireless standards including the IEEE 802.11n and the IEEE 802.11ac standards. The STAs 110 and 115 can be, for example, laptop computers, smart phones, tablet computers, printers, or any other wireless device with or without a user interface.

Current IEEE 802.11n/ac devices such as STAs 110 and 115 can operate on certain sub-bands of the 5 GHz frequency band. Recently, the Federal Communications Commission (FCC) has proposed modification of the existing rules governing U-NII (Unlicensed-National Information Infrastructure) use of the 5 GHz frequency band by which 195 MHz of additional spectrum is allocated for U-NII shared access in the 5350-5470 MHz and 5850-5925 MHz sub-bands of the 5 GHz frequency band.

Several governmental agencies currently use the two aforementioned 5 GHz expansion bands. Non-governmental uses include fixed satellite uplinks (Earth-to-space) and mobile services. The non-governmental mobile service allocation is currently limited to systems such as Dedicated Short Range Communications Service (DSRCS) systems 120 and 125 operating in the Intelligent Transportation System (ITS) radio service. The IEEE 802.11p amendment specifies enhancements to 802.11 to support ITS applications. The FCC may require that STAs 110 and 115 desiring to operate in these or other sub-bands of the 5 GHz frequency band implement situation-aware spectrum-sharing technologies to co-exist with IEEE 802.11p devices such as systems 120 and 125.

IEEE 802.11p devices can operate over 5 MHz, 10 MHz, and 20 MHz bandwidths. However, some IEEE 802.11n/ac devices, such as STAs 110 and 115, can operate only at bandwidths of 20 MHz or greater. Accordingly, current 802.11n/ac devices may be unable to detect IEEE 802.11p devices operating with 5 or 10 MHz bandwidths. One approach is to detect the IEEE 802.11p signal and defer until the media is idle to meet the FCC requirements. However, this approach may not allow the IEEE 802.11n/ac device 110, 115 to be more aware of the environment in which it operates, which can lead to inefficiencies in operation of the IEEE 802.11n/ac device 110, 115.

To address these and other concerns, some embodiments allow IEEE 802.11n/ac STAs 110, 115 to detect and demodulate the IEEE 802.11p transmission to determine how long to defer and to more accurately identify transmitted signals as IEEE 802.11p signals. This knowledge allows IEEE 802.11n/ac STAs 110, 115 to apply more efficient coexistence techniques. Additionally, this knowledge can allow future signaling to be added in future IEEE 802.11 amendments.

An IEEE 802.11p packet has a same structure as an IEEE 802.11n/ac packet. In particular, similarly to IEEE 802.11a/n/ac packets, an IEEE 802.11p packet includes a short training field (STF) followed by a long training field (LTF). The LTF is followed by a signal (SIG) field, and the SIG field is followed by a MAC header. In some embodiments, STA 110 may at least partially decode these and other fields of the IEEE 802.11p packet.

The SIG field contains a packet duration, for example a packet length and data rate, for use in determining how long to defer transmissions or perform other coexistence techniques. The MAC header includes a network allocation vector (NAV) that may also be used for determining how long to defer transmissions or for performing other coexistence techniques. With information of the SIG, and the NAV, STA 110 can apply coexistence techniques by, for example, delaying usage of the channel until such a time as the channel will no longer be in use by that packet. By knowing the information, STA 110 can wait a sufficient amount of time before attempting transmission or other operations on the channel, while avoiding waiting an excessive amount of time. In some embodiments, STA 110 may decode other information in the SIG field or other fields of the transmitted packet.

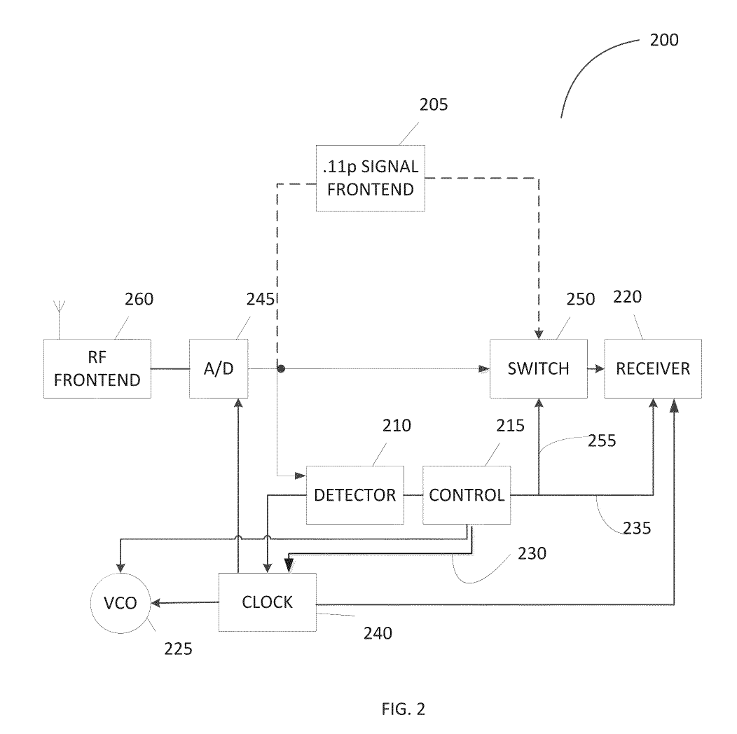

FIG. 2 is a block diagram of STA architecture 200 for coexisting with devices on the 5 GHz frequency band. The architecture can be implemented within STA 110 (FIG. 1) on one or more components of STA 110.

As shown in FIG. 2, in some embodiments, STA 110 can include an ancillary processing path (shown with the dashed lines of FIG. 2) to connect to an 0.11p signal frontend 205 and perform processing for signals received from IEEE 802.11p devices, for example DSRCS systems that are part of the ITS radio service. 0.11p signal frontend 205 processes IEEE 802.11p signals that have other than a 20 MHz bandwidth. For example, 0.11p signal frontend 205 can process IEEE 802.11p signals with a 5 MHz bandwidth or a 10 MHz bandwidth. 0.11p signal frontend 205 filters the IEEE 802.11p signal to an appropriate bandwidth and then down-samples the IEEE 802.11p signal to a sampling rate commensurate with the IEEE 802.11p signal. After the ancillary processing path is implemented, or in parallel with implementation of the ancillary processing path, processing may continue in the standard path of the remainder of FIG. 2, with adjustments as described below.

The ancillary processing path through 0.11p signal frontend 205 may be invoked based on a determination of a detector 210. Detector 210 can detect whether a received signal is an IEEE 802.11n/ac or IEEE 802.11p signal. Detector 210 connects to a control block 215 that controls receiver 220 based on information detected at detector 210. Detector 210 may provide information on the operating bandwidth of the IEEE 802.11p signal, and information on the frequency on which the IEEE 802.11p signal is centered. For example, if STA 110 is a 20 MHz system operating in a frequency band that overlaps four 5-MHz IEEE 802.11p channels (or two 10-MHz IEEE 802.11p channels) then detector 210 may provide information as to which of the four MHz IEEE 802.11p channels, for example, contains the signal. The detector 210 can provide this information by, for example, separating a received signal into subchannels of 5 MHz, 10 MHz or any other bandwidth smaller than or equal to the smallest operating bandwidth of the STA 110. The detector 210 may also separate a received signal into subchannels with two or more of these bandwidths. The bandwidth of these subchannels may be based on the expected bandwidth of transmissions of a device operating on a 5 GHz transmission band. In an example, the detector 210 can then detect a Short Training Sequence (STS) portion of a data packet on one subchannel of the subchannels. The STS portion can be detected by inspecting the subchannels, in parallel, for a time duration based on the periodicity of the STS portion at that bandwidth.

Control block 215 sends a signal to voltage controlled oscillator (VCO) 225 or other hardware controlling an RF carrier frequency to provide the appropriate frequency offset so that the center operating frequency of the STA 110 is at the center of the 10-MHz or 5-MHz IEEE 802.11p signal.

Control block 215 can also provide control over control lines 230 and 235 to clock 240 and receiver 220. Control line 235 configures receiver 220 based on the received waveform. Control line 235 may notify receiver 220 when an IEEE 802.11p signal is present. Based on control line 235, receiver 220 may adjust for a different sampling rate and receiver 220 may adjust algorithms based on the different sub-carrier spacing for IEEE 802.11p signals.

Clock 240 may send a separate, slower clock signal to receiver 220 in some situations, based on the commands or signals received on the control line 230. Clock 240 may also send a slower clock signal to A/D block 245, based on longer symbol time for IEEE 802.11p signals. A/D block 245 may provide the lower sampling rate to 0.11p signal frontend 205.

Switch 250 receives a signal 255 from the control block 215 indicating whether the signal is an IEEE 802.11n/ac or IEEE 802.11p signal. The switch 250 indicates this information to the receiver 220. This information may be used when a 20-MHz IEEE 802.11p signal is received, to help the receiver 220 differentiate from a 20 MHz IEEE 802.11n/ac signal, and so that STA 110 can apply coexistence techniques for coexisting with IEEE 802.11p devices 120, 125 with 20 MHz bandwidths.

Using a clock rate that was received from clock 240 and based on the knowledge as to whether the signal was an IEEE 802.11n/ac or IEEE 802.11p signal, receiver 220 can adjust the algorithms, the center frequency, and other parameters to detect information in the SIG and MAC header. STA 110 can then use this information for applying coexistence techniques, for implementing power savings modes, or for other functionalities. For example, receiver 220 may implement functionality to enter a sleep mode for a time period indicated in the SIG and MAC header (such as a time period indicated by, for example the packet length and NAV as described above), or refrain from transmitting on the channel for a time period as explained above.

The architecture 200 can also include an RF Frontend 260 to convert a signal, received from an antenna at a radio frequency, to an intermediate frequency that can be processed by the other components of the STA 110. The RF Frontend 260 can include, for example, an impedance matching circuit for impedance matching with an antenna, band pass filters, RF amplifiers, or other components. The RF Frontend 260 can include a MIMO frontend with multiple antennas.

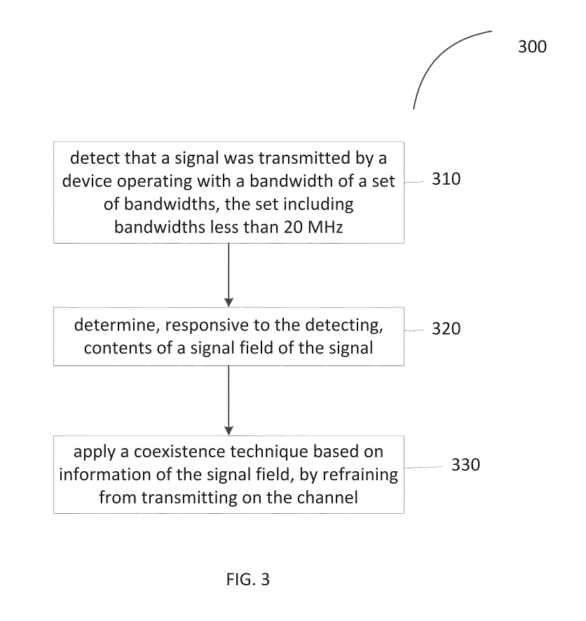

FIG. 3 is a flow diagram of a procedure 300 performed by a STA for operating in a wireless network, in accordance with some embodiments. The procedure can be performed by, for example, STA 110 or 115 (FIG. 1).

In operation 310, STA 110 detects that a signal, received on a wireless communication channel, was transmitted by a device operating with a bandwidth of a set of bandwidths. STA 110 can detect this signal using an architecture as described above with respect to FIG. 2. The set of bandwidths can include bandwidths less than 20 MHz, for example 5 MHz and 10 MHz bandwidths. If the device is transmitting using a 20 MHz or larger bandwidth, STA 110 can detect that this is a DSCRS device based on information output by detector 210 (FIG. 2). The frequency of the transmissions may be in a frequency range from about 5.85 GHz to 5.925 GHz, or from about 5.350 GHz to 5.470 GHz, in accordance with a standard of the IEEE 802.11 family of standards. However, embodiments are not limited to detection of transmissions in these frequency ranges.

In operation 320, STA 110 determines contents of a SIG field of the signal. As described above, the contents of the SIG field can include packet length and data rate. STA 110 may also determine contents of a MAC header of the signal. As described above, the contents of the MAC header can include a network allocation vector (NAV). As described above with respect to FIG. 2, STA 110 can determine contents of the SIG field by adjusting a system clock and a center operating frequency based on the bandwidth at which the device is operating, and sampling the signal, at the center frequency and based on the system clock, to detect the STF waveform.

STA 110 may provide a separate low-power and low-speed clock signal line responsive to determining that the device from which STA 110 received the signal operates in accordance with a standard of the IEEE family of standards that defines support for ITS services.

In operation 330, STA 110 applies a coexistence technique based on information of the SIG field, by refraining from transmitting on the channel. The coexistence technique may include deferring transmissions based on information in the SIG field and MAC header as described above. STA 110 implements coexistence techniques to avoid interfering with device 120 or 125 (FIG. 1) on the 5 GHz frequency band.

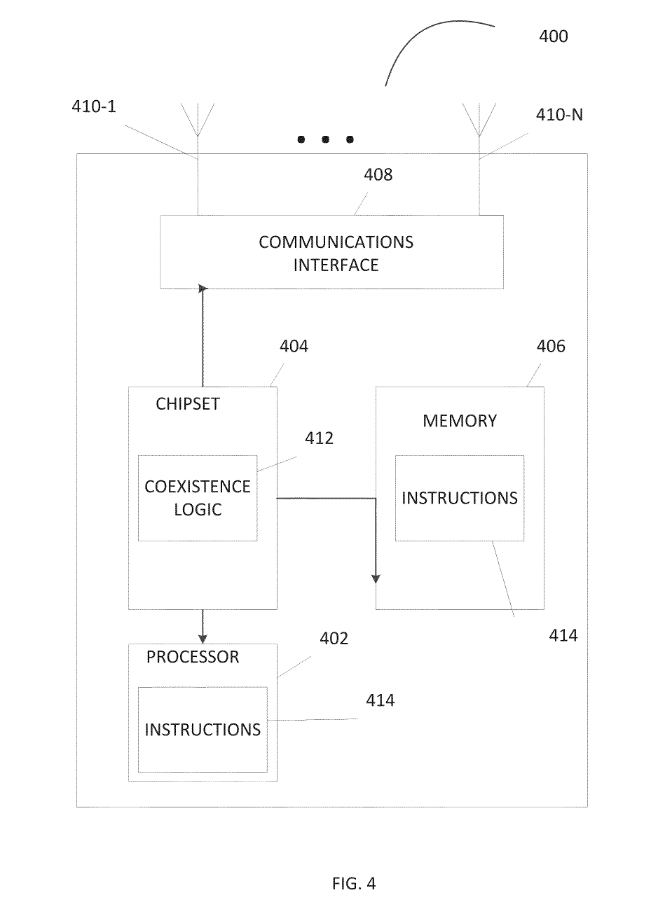

FIG. 4 illustrates a functional block diagram of a STA 400, in accordance with some embodiments. STA 400 may be suitable as a STA 110 (FIG. 1). STA 400 supports methods for operating in a wireless communication network, in accordance with embodiments. STA 400 may communicate in accordance with a standard of the IEEE 802.11n family of standards or with a standard of the IEEE 802.11ac family of standards or amendments or future versions thereof.

STA 400 can include a processor 402, which uses a chipset 404 to access on-chip state memory 406, as well as a communications interface 408. In one embodiment memory 406 includes, but is not limited to, random access memory (RAM), dynamic RAM (DRAM), static RAM (SRAM), synchronous DRAM (SDRAM), double data rate (DDR) SDRAM (DDR-SDRAM), or any device capable of supporting high-speed buffering of data.

In at least one embodiment, communications interface 408 is, for example, a wireless Physical Layer (PHY), which operates according to a multiple input/multiple output (MIMO) operation. Communications interface 408 receives a signal at least on a wireless communication channel in the 5 GHz band. For example, communications interface 408 can receive a signal in a frequency range from about 5.85 GHz to 5.925 GHz.

Chipset 404 may incorporate therein coexistence logic 412 to, for example, suppress transmission on the wideband communication channel for at least a time duration. In an embodiment, chipset 406 provides MAC layer functionality.

Embodiments may be implemented in one or a combination of hardware, firmware and software. Embodiments may also be implemented as instructions 414 stored on a non-transitory computer-readable storage device, which may be read and executed by at least one processor 402 to perform the operations described herein.

Processor 402 detects whether a signal was received from a device operating in accordance with a standard of the Institute of Electrical and Electronics Engineers (IEEE) family standards that defines support for Intelligent Transportation System (ITS) services using a bandwidth of a set of bandwidths. The set of bandwidths may include a 5 MHz bandwidth and a 10 MHz bandwidth. Processor 402 can determine, responsive to the detecting, contents of a SIG field of the signal. Processor 402 applies a coexistence technique based on information of the SIG field. For example, processor 402 may refrain from transmitting on the channel.

In some embodiments, instructions 414 are stored on processor 402 or memory 406 such that processor 402 and memory 406 act as computer-readable media. A computer-readable storage device can include any non-transitory mechanism for storing information in a form readable by a machine (e.g., a computer). For example, a computer-readable storage device may include ROM, RAM, magnetic disk storage media, optical storage media, flash-memory devices, and other storage devices and media.

Instructions 414, when executed on STA 400, may cause STA 400 to receiving a signal on a wireless communication channel in a frequency range from about 5.85 GHz to 5.925 GHz. Instructions 414, when executed on STA 400, may cause STA 400 to detect that the signal was received from a device operating in accordance with a standard of the Institute of Electrical and Electronics Engineers (IEEE) family standards that defines support for Intelligent Transportation System (ITS) services using a bandwidth of a set of bandwidths. The set of bandwidths may include a 5 MHz bandwidth and a 10 MHz bandwidth. Instructions 414, when executed on STA 400, may cause STA 400 to determining, responsive to the detecting, contents of a SIG field of the signal. Instructions 414, when executed on STA 400, may cause STA 400 to apply a coexistence technique based on information of the SIG field, by refraining from transmitting on the channel.

Although STA 400 is illustrated as having several separate functional elements, one or more of the functional elements may be combined and may be implemented by combinations of software-configured elements, such as processing elements including digital signal processors (DSPs) and/or other hardware elements. For example, some elements may comprise one or more microprocessors, DSPs, application specific integrated circuits (ASICs), radio-frequency integrated circuits (RFICs), and combinations of various hardware and logic circuitry for performing at least the functions described herein. In some embodiments, the functional elements of STA 400 may refer to one or more processes operating on one or more processing elements.

STA 400 may include multiple transmit and receive antennas 410-1 through 410-N, where N is a natural number. Antennas 410-1 through 410-N may comprise one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some MIMO embodiments, antennas 410-1 through 410-N may be effectively separated to take advantage of spatial diversity and the different channel characteristics that may result between each of antennas 410-1 through 410-N. In some MIMO embodiments, antennas 410-1 through 410-N may be separated by up to 1/10 of a wavelength or more. In some embodiments, antennas 410-1 through 410-N may include bandpass filters or other filtering circuitry to filter a received signal into various subchannels with different bandwidths, for example 5 MHz, 10 MHz, 20 MHz, or other bandwidths.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

### OTHER EXAMPLES

The following are illustrative and non-limiting examples.

Example 1 includes subject matter (such as a method, means for performing acts, machine readable medium including instructions) comprising a method performed by a user station (STA), for operating in a wireless network, the method including detecting that a signal, received on a wireless communication channel, was transmitted by a device operating with a bandwidth of a set of bandwidths, the set including bandwidths less than 20 MHz; determining, responsive to the detecting, contents of a SIG field of the signal; and applying a coexistence technique based on information of the SIG field, by refraining from transmitting on the channel.

In example 2, the subject matter of example 1 may optionally include, wherein the information includes a packet length and the coexistence technique includes deferring transmissions based on the packet length.

In example 3, the subject matter of one or more of examples 1-2 may optionally include, wherein the set of bandwidths includes a bandwidth of 5 MHz and a bandwidth of 10 MHz.

In example 4, the subject matter of one or more of examples 1-3 may optionally include determining whether the device is a device for operating in accordance with a standard of the Institute of Electrical and Electronics Engineers (IEEE) family standards that defines support for Intelligent Transportation System (ITS) services; and applying a coexistence technique if the signal transmitted by the device uses a 20 MHz bandwidth.

In example 5, the subject matter of examples 1-4 may optionally include, wherein the signal is received in a frequency range from about 5.85 GHz to 5.925 GHz.

In example 6, the subject matter of example 1-5 may optionally include, wherein providing a separate low-power and low-speed clock signal line responsive to determining that the device operates in accordance with a standard of the IEEE family of standards that defines support for ITS services.

In example 7, the subject matter of one or more of examples 1-6 may optionally include adjusting a system clock and a center operating frequency of the STA based on the bandwidth at which the device is operating; and sampling the signal, at the center frequency and based on the system clock, to detect the STF waveform.

Example 8 includes or may optionally be combined with the subject matter of any one of examples 1-7 to include subject matter (such as a device, apparatus, or machine) including a wireless communication station (STA) comprising physical layer (PHY) circuitry and processing elements to: detect that a signal, received on a wireless communication channel in a frequency range from about 5.85 GHz to 5.925 GHz, was transmitted by a device operating with a bandwidth of a set of bandwidths, the set including a bandwidth of 5 MHz and a bandwidth of 10 MHz; determine, responsive to the detecting, contents of a SIG field of the signal; and apply a coexistence technique for operating on the channel based on information in the SIG field of the signal, the coexistence technique including refraining from transmitting on the channel.

In example 9, the subject matter of any one or more of examples 1-8 may optionally include, wherein the coexistence technique includes deferring transmissions based on information in the SIG field.

In example 10, the subject matter of any one or more of examples 1-9 may optionally include, wherein the PHY circuitry and processing elements are configured to determining whether the device is a device for operating in accordance with a standard of the Institute of Electrical and Electronics Engineers (IEEE) family standards that defines support for Intelligent Transportation System (ITS) services.

In example 11, the subject matter of any one or more of examples 1-10 may optionally include, wherein the processing elements are further configured to apply a coexistence technique if the signal transmitted by the device uses a 20 MHz bandwidth.

In example 12, the subject matter of any one or more of examples 1-11 may optionally include a separate low-power and low-speed clock signal for use with communicating with devices that operate in accordance with a standard of the IEEE family of standards that defines support for ITS services.

In example 13, the subject matter of any one or more of examples 1-12 may optionally include wherein the PHY circuitry and the processing elements determine contents of the SIG field by adjusting a system clock and a center operating frequency of the STA based on the bandwidth at which the device is operating, and sampling the signal, at the center frequency and based on the system clock, to detect the STF waveform.

Example 14 includes or may optionally be combined with the subject matter of any one of examples 1-13 to include subject matter (such as a device, apparatus, or machine) comprising a system comprising: an antenna configured to receive a signal on a wireless communication channel in a frequency range from about 5.85 GHz to 5.925 GHz; and one or more processors configured to: detect that the signal was received from a device operating in accordance with a standard of the Institute of Electrical and Electronics Engineers (IEEE) family standards that defines support for Intelligent Transportation System (ITS) services using a bandwidth of a set of bandwidths, the set including a 5 MHz bandwidth and a 10 MHz bandwidth; determine, responsive to the detecting, that contents of a SIG field of the signal; and apply a coexistence technique based on information of the SIG field, by refraining from transmitting on the channel for a time duration.

In example 15, the subject matter of one or more of examples 1-14 may optionally include, wherein the contents include a packet length, and the coexistence technique includes deferring transmissions based on the packet length.

In example 16, the subject matter of one or more of examples 1-15 may optionally include a separate low-power and low-speed clock signal line for communicating with a device that operates in accordance with a standard of the IEEE family of standards that defines support for ITS services.

In example 17, the subject matter of one or more of examples 1-16 may optionally include wherein the one or more processors determine contents of the SIG field by adjusting a system clock and a center operating frequency of the system based on the bandwidth at which the device is operating, and sampling the signal, at the center frequency and based on the system clock, to detect the STF waveform.

Example 18 includes or may optionally be combined with the subject matter of any one of examples 1-17 to include subject matter (such as a method, means for performing acts, machine readable medium including instructions) comprising: receiving a signal on a wireless communication channel in a frequency range from about 5.85 GHz to 5.925 GHz; detecting that the signal was received from a device operating in accordance with a standard of the Institute of Electrical and Electronics Engineers (IEEE) family standards that defines support for Intelligent Transportation System (ITS) services using a bandwidth of a set of bandwidths, the set including a 5 MHz bandwidth and a 10 MHz bandwidth; determining, responsive to the detecting, contents of a SIG field of the signal; and applying a coexistence technique on the channel responsive to the detecting, the coexistence technique including refraining from transmitting on the channel.

In example 19, the subject matter of one or more of examples 1-18 may optionally include, wherein the contents include a packet length, and the coexistence technique includes deferring transmissions based on the packet length.

In example 20, the subject matter of one or more of examples 1-19 may optionally include, wherein the determining includes adjusting a system clock and a center operating frequency of the system based on the bandwidth at which the device is operating, and sampling the signal, at the center frequency and based on the system clock, to detect the STF waveform.

1.-20. (canceled)

21. A method, performed by a user station (STA), for operating in a wireless network, the method comprising:
detecting that a signal, received on a wireless communication channel, was transmitted by a device operating with a bandwidth of a set of bandwidths, the set including bandwidths less than 20 MHz;
determining, responsive to the detecting, contents of a signal (SIG) field of the signal; and
applying a coexistence technique based on information of the SIG field, by refraining from transmitting on the channel.

22. The method of claim 21, wherein the information includes a packet length, and the coexistence technique includes deferring transmissions based on the packet length.

23. The method of claim 21, wherein the set of bandwidths includes a bandwidth of 5 MHz and a bandwidth of 10 MHz.

24. The method of claim 23, further comprising:
determining whether the device is a device for operating in accordance with a standard of the Institute of Electrical and Electronics Engineers (IEEE) family standards that defines support for Intelligent Transportation System (ITS) services; and
applying a coexistence technique if the signal transmitted by the device uses a 20 MHz bandwidth.

25. The method of claim 24, wherein the signal is received in a frequency range from about 5.85 GHz to 5.925 GHz.

26. The method of claim 24, further comprising:
providing a separate low-power and low-speed clock signal line responsive to determining that the device operates in accordance with a standard of the IEEE family of standards that defines support for ITS services.

27. The method of claim 21, wherein determining contents of the SIG field comprises:
adjusting a system clock and a center operating frequency of the STA based on the bandwidth at which the device is operating; and
sampling the signal, at the center frequency and based on the system clock, to detect the STF waveform.

28. A wireless communication station (STA) comprising physical layer (PHY) circuitry and processing elements to:
detect that a signal, received on a wireless communication channel in a frequency range from about 5.85 GHz to 5.925 GHz, was transmitted by a device operating with a bandwidth of a set of bandwidths, the set including a bandwidth of 5 MHz and a bandwidth of 10 MHz;
determine, responsive to the detecting, contents of a signal (SIG) field of the signal; and
apply a coexistence technique for operating on the channel based on information in the SIG field of the signal, the coexistence technique including refraining from transmitting on the channel.

29. The STA of claim 28, wherein the coexistence technique includes deferring transmissions based on information in the SIG field.

30. The STA of claim 28, wherein the PHY circuitry and processing elements are further configured to
determining whether the device is a device for operating in accordance with a standard of the Institute of Electrical and Electronics Engineers (IEEE) family standards that defines support for Intelligent Transportation System (ITS) services.

31. The STA of claim 30, wherein the processing elements are further configured to apply a coexistence technique if the signal transmitted by the device uses a 20 MHz bandwidth.

32. The STA of claim 28, further including:
a separate low-power and low-speed clock signal for use with communicating with devices that operate in accordance with a standard of the IEEE family of standards that defines support for ITS services.

33. The STA of claim 28, wherein the PHY circuitry and the processing elements determine contents of the SIG field by adjusting a system clock and a center operating frequency of the STA based on the bandwidth at which the device is operating, and sampling the signal, at the center frequency and based on the system clock, to detect the STF waveform.

34. A system comprising:
an antenna configured to receive a signal on a wireless communication channel in a frequency range from about 5.85 GHz to 5.925 GHz; and
one or more processors configured to
detect that the signal was received from a device operating in accordance with a standard of the Institute of Electrical and Electronics Engineers (IEEE) family standards that defines support for Intelligent Transportation System (ITS) services using a bandwidth of a set of bandwidths, the set including a 5 MHz bandwidth and a 10 MHz bandwidth;
determine, responsive to the detecting, that contents of a signal (SIG) field of the signal; and
apply a coexistence technique based on information of the SIG field, by refraining from transmitting on the channel.

35. The system of claim 34, wherein the contents include a packet length, and the coexistence technique includes deferring transmissions based on the packet length.

36. The system of claim 34, further comprising:
a separate low-power and low-speed clock signal line for communicating with a device that operates in accordance with a standard of the IEEE family of standards that defines support for ITS services.

37. The system of claim 34, wherein the one or more processors determine contents of the SIG field by adjusting a system clock and a center operating frequency of the system based on the bandwidth at which the device is operating, and sampling the signal, at the center frequency and based on the system clock, to detect the STF waveform.

38. A non-transitory computer-readable storage medium that stores instructions for execution by one or more processors to perform operations comprising:
receiving a signal on a wireless communication channel in a frequency range from about 5.85 GHz to 5.925 GHz;
detecting that the signal was received from a device operating in accordance with a standard of the Institute of Electrical and Electronics Engineers (IEEE) family standards that defines support for Intelligent Transportation System (ITS) services using a bandwidth of a set of bandwidths, the set including a 5 MHz bandwidth and a 10 MHz bandwidth;
determining, responsive to the detecting, contents of a signal (SIG) field of the signal; and
applying a coexistence technique based on information of the SIG field, by refraining from transmitting on the channel.

39. The non-transitory computer-readable storage medium of claim 38, wherein the contents include a packet length, and the coexistence technique includes deferring transmissions based on the packet length.

40. The non-transitory computer-readable storage medium of claim 39, wherein the determining includes adjusting a system clock and a center operating frequency of the system based on the bandwidth at which the device is operating, and sampling the signal, at the center frequency and based on the system clock, to detect the STF waveform.
